(19) United States
(12) Patent Application Publication
(10) Pub. No.: US 2004/0153372 A1
(43) Pub. Date: Aug. 5, 2004

(54) Internet-based sales system and method for selling a select inventory of carpets

(76) Inventor: Daniel C. Pilzer, Marietta, GA (US)

Correspondence Address: Walter A. Rodgers, 880 North Island Drive, Atlanta, GA, 30327, US

(21) Appl. No.: 10/354,676

(22) Filed: Jan. 30, 2003

(51) Int. Cl. G06F 17/60

(52) U.S. Cl. 705/26

(57) ABSTRACT

The present invention involves a sales system for selling a selected inventory of commercial carpets over the Internet. Such an inventory may include carpets that are over-runs, off-color, discontinued styles, or have minor manufacturing defects. It should also be pointed out that while some of these carpets may be classified as “seconds,” a large quantity of carpets, such as those from discontinued styles and close-outs, are first quality merchandise. The sales system simultaneously addresses the needs of carpet customers such as small business customers seeking a larger selection of commercial carpets at lower prices; carpet dealers seeking easier means to acquire and sell commercial carpets with acceptable profit margins through their retail outlets; and carpet manufacturers seeking to dispose of certain types of carpets thereby increasing their revenue stream.

### FIELD OF THE INVENTION

The present invention is generally related to a business model for using the Internet to implement a sales system for selling a special inventory of commercial-grade carpets.

### DESCRIPTION OF THE RELATED ART

There are two distinct categories of carpets in the carpet business—residential carpets and commercial carpets. Apart from the differences in the nature of the material as well as the performance characteristics of the carpets in these two categories, the marketing of these two product categories is implemented using two distinctly different procedures.

Residential carpets are used predominantly by homeowners, and are sold through a large network of retail outlets. Commercial carpets are used by both large and small businesses. Sales to the large-business customers are typically carried out through a limited network of dealers who cater to this high-end corporate clientele. Small business customers such as restaurants, retail stores, and home-offices, that need commercial carpets using limited budgets, attempt to find these products at discounted prices through the retail outlets selling residential carpets. This is generally a frustrating effort, because the selection of commercial carpets at such locations is limited and the prices are inflexible due to a paucity of dealers selling commercial-grade carpets through such outlets.

From the point of view of the carpet dealer who owns a retail outlet, procuring and selling commercial carpets to small businesses is a tedious task involving a sales process that has to target a limited clientele looking for low prices. Consequently, the return of investment from selling commercial carpets becomes unattractive to such a carpet dealer.

From a carpet manufacturer's point of view, the existing sales system for selling commercial carpets such as the one through retail outlets, is an unsatisfactory arrangement, as it does not maximize revenue. This situation is especially unwarranted when the problem can be resolved if a marketing tool existed to advertise and sell a select inventory of commercial carpets that can be sold at discounted prices. Carpet types that fall under this category include carpets that are over-runs, off-color, discontinued styles, or have minor manufacturing defects. It should also be pointed out that while some of these carpets may be classified as “seconds,” a large quantity of carpets, such as those from discontinued styles and close-outs, are first quality merchandise.

Given the availability of the Internet and its power to implement e-commerce, a need exists to create a user-interactive sales system that will simultaneously address the needs of carpet customers such as small business customers seeking a larger selection of commercial carpets at lower prices; carpet dealers seeking easier means to acquire and sell commercial carpets with acceptable profit margins through their retail outlets; and carpet manufacturers seeking to dispose of certain types of carpets thereby increasing their revenue stream.

### SUMMARY OF THE INVENTION

The present invention involves an Internet-based sales system, the sales system comprising, in one embodiment of the invention, a host computer configured to operate as a webhost server coupled to the Internet together with a database storage in the host computer. The database storage contains information on selected commercial-grade carpets, and a means for allowing a carpet dealer to access a first part of the database storage over the Internet. The system also provided means for a commercial carpet customer to access a second part of the database, obtain pricing information and purchase a selected inventory of commercial grade carpet.

A second embodiment provides a method for selling commercial carpets. In this method an information database of a selected inventory of commercial carpets is provided, with an authenticated access procedure to allow a carpet dealer to a first part of the database, while preventing access to this part of the database by a commercial carpet customer. A commercial carpet customer is provided access to a second part of the database.

Clearly, some embodiments of the invention may exhibit advantages in addition to, or in lieu of, those mentioned above. Additionally, other systems, methods, features and/or advantages of the present invention may become apparent to one with skill in the art upon examination of the following drawings and detailed description. It is intended that all such additional systems, methods, features and/or advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 illustrates an Internet-based sales system for selling commercial grade carpets in accordance with the present invention.

FIG. 2 shows a typical computing system inside a host computer to implement the sales system of the invention.

FIG. 3 illustrates some of the types of information that may be incorporated into the information database of FIG. 2.

FIG. 4 is a flow chart describing operational details of the sales system of the present invention.

FIG. 5 is a flow chart describing a typical operation when a customer visits the sales website.

### DETAILED DESCRIPTION

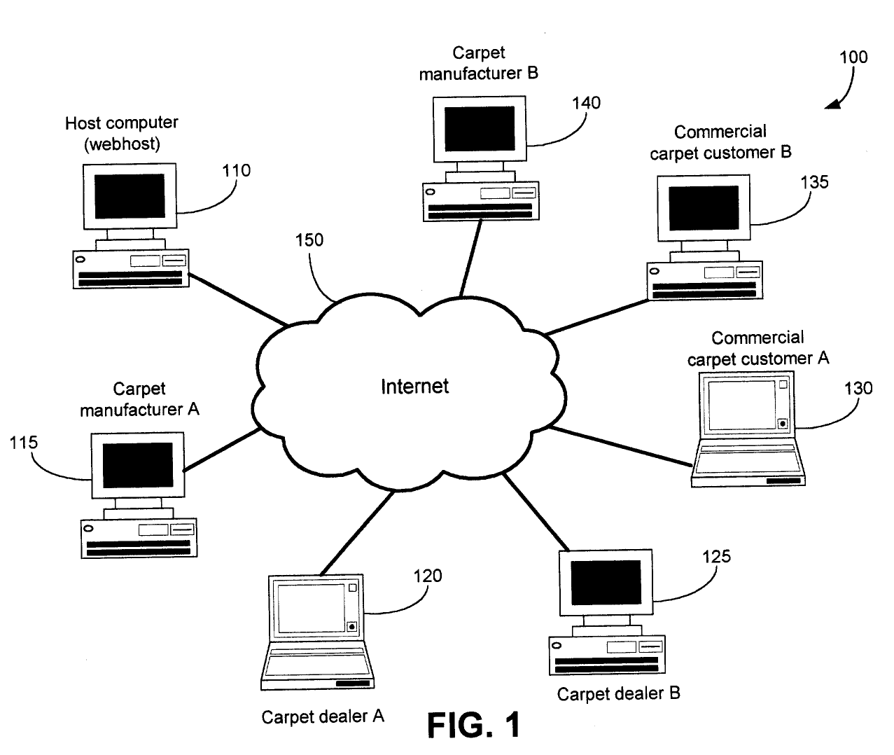

Referring now to the drawings, FIG. 1 illustrates an Internet-based sales system 100 for selling commercial grade carpets in accordance with the present invention. A host computer 110 configured to operate as a webhost server is shown connected to the Internet 150. Host computer 110 will be typically maintained and updated by a sales system administrator. The system administrator installs and operates an information database located inside host computer 110. The information database will provide information related to conducting business, such as availability, pricing, shipping details, contact information, and commerce transactions such as associated with credit card purchases. Product availability information encompasses the creation of a website warehouse displaying a wide range of virtual images, and product information under suitable classification sections that may include hyperlinks to several associated uniform resource locators (URLs), as well as clickable link labels and radio buttons.

The pricing information is divided into two major categories—one for access by commercial carpet customers and the other for access by carpet dealers. The prices for use by carpet dealers would be typically set lower than those for use by the commercial carpet customers. This allows carpet dealers to purchase carpets at retail prices and re-sell them at suitably marked-up sales prices that may still remain competitively lower than prevailing market prices at retail outlets that do not use this sales system.

Access by carpet dealers is controlled by an authentication process that may include the use of passwords. Passwords are uniquely assigned to each carpet dealer. Use of such passwords includes functions such as denying access by commercial carpet customers to the dealer pricing database. While passwords may also be provided to commercial carpet customers, a typical access process for a customer will be less stringent. Such access will be universal due to the nature of e-commerce, and advertisements may be used in media such as newspapers, television, and radio to attract customers to the Internet based sales system.

Access by carpet dealers will be typically carried out using a PC, such as PC 120 and PC 125 that are connected to the host computer 110 via the Internet 150. PC 120 may be located in the business premises of retail carpet dealer A, while PC 125 may be located in a residential office of retail carpet dealer B.

Access by commercial carpet customers will be typically carried out using a PC, such as PC 130 and PC 135 that are connected to the host computer 110 via the Internet 150. PC 130 may for example, be located in the business premises of a small business customer A who is a typical commercial carpet customer, while PC 135 may be located in a residential office of small business customer B.

PC 115 belongs to a carpet manufacturer A, while PC 140 is owned by a second carpet manufacturer B. Carpet manufacturer A accesses host computer 110 via Internet 150 and uses this access to update and modify the information database in host computer 110. In this access, carpet manufacturer A may operate in the capacity of a primary webhost administrator, a secondary webhost administrator, or an auxiliary webhost administrator. Carpet manufacturer B may also access host computer 110 via Internet 150, and carry out the activities mentioned earlier with reference to carpet manufacturer A.

As auxiliary webhost administrators, both carpet manufacturer A and carpet manufacturer B may implement daily updates such as making current their respective data related to their respective carpets, independent of each other. This type of independent access by one or more carpet manufacturers permits a large inventory of carpets displayed by host computer 110 to be accurate on a constantly updated basis. This update may occur as frequently as a daily rate. PCs 115 and 140 may also be operated as auxiliary host computers, which have hyperlink connectivity to host computer 110. Under this type of system, the auxiliary data bases in these two computers can be accessed locally by the two manufacturers without the need for data transfers between PC 115 or PC 140 and the distantly located host computer 110.

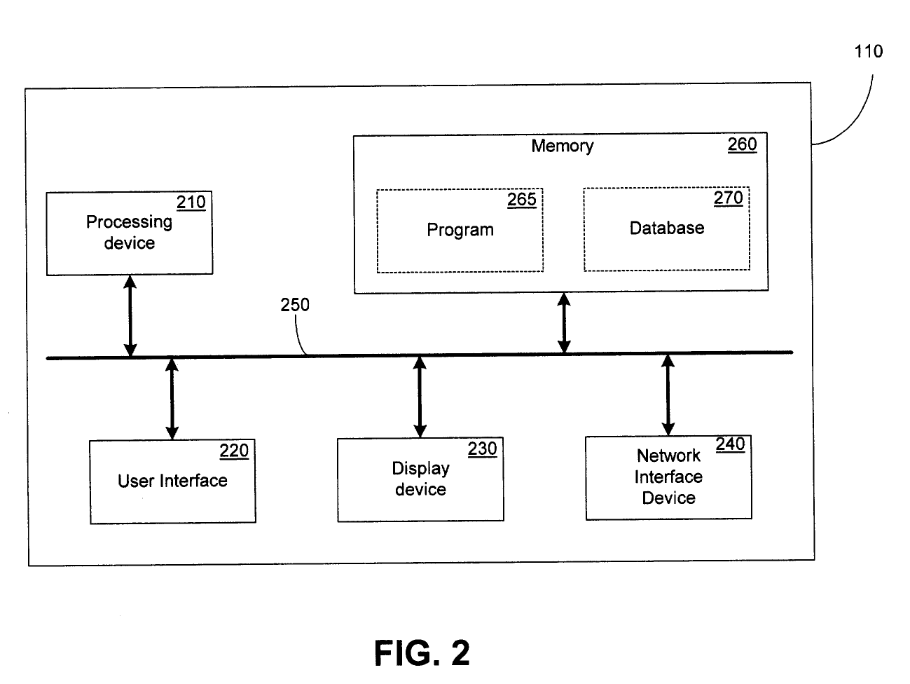

FIG. 2 shows a typical computing system inside host computer 110 to implement the sales system of the invention. Processing device 210 may be a central processing unit (CPU) such as a Pentium microprocessor or a mainframe CPU that is connected to a communication bus 250. User interface 220, which is also connected to communication bus 250, may be one of several devices, such as keyboard, a mouse, or a touchscreen for an operator, such as a webhost administrator to enter database information or carry out other computing processes upon host computer 110. Display device 230 may be one of several devices, such as a PC monitor or an LCD display screen.

Network interface device (NID) 240 facilitates data carried on communication bus 250 to be communicated to an external network. The external network is typically a local area network (LAN) or may be an Internet provider's host server. The Internet host server is often connected to the NID via a traditional POTS line or a DSL line. This permits host computer 110 to couple into the Internet 150 (as shown in FIG. 1).

Memory device 260, which is connected to communication bus 250, encompasses several types of computer-readable media, such as magnetic hard drives, floppy disks, CD ROMs, DVDs, and a variety of semiconductor memories such as EPROMs, DRAMs, and RAMs. Contents of memory device 260 include two of several programs. Such programs may be implemented as software, firmware, and dedicated as well as configurable logic including PLDs, FPGAs, and ASICs. Program 265 may be used to carry out the functional activities of host computer 110. Such a program 265 is well known in the art, and encompasses a variety of programs such as system operating systems, application software, and communication software. This will be typically used by the administrator to access the database 270. Database 270 is information that is related to implementing the sales system of this invention.

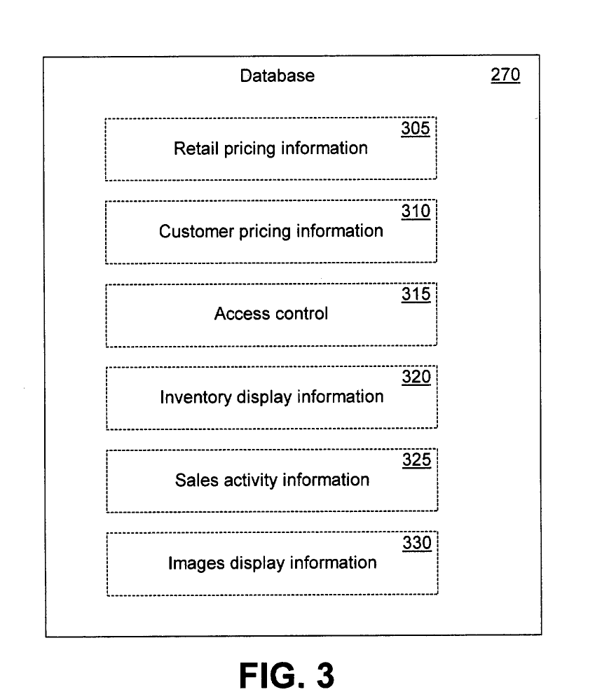

FIG. 3 illustrates some of the types of information that may be incorporated into the information database of FIG. 2. Retail pricing information 305 is made available to carpet dealers, as explained earlier, while customer pricing information 310 is made available to commercial carpet customers. Access control 315 controls access to one or both of the retail pricing information 305 and customer pricing information 310. Access control 315 also includes password-controlled access procedures, such as password storage, username storage, and access blocking.

Inventory display information 320, sales activity 325, and images display information 330 are three of several examples of database implementations that may be accessed and modified by operators such as the webhost administrator. Sales activity information 325 also includes a wide range of other functions, such as e-commerce related actions needed for credit card purchases, and providing status of sales transactions. Status information data includes shipping details, sample delivery, and back-orders.

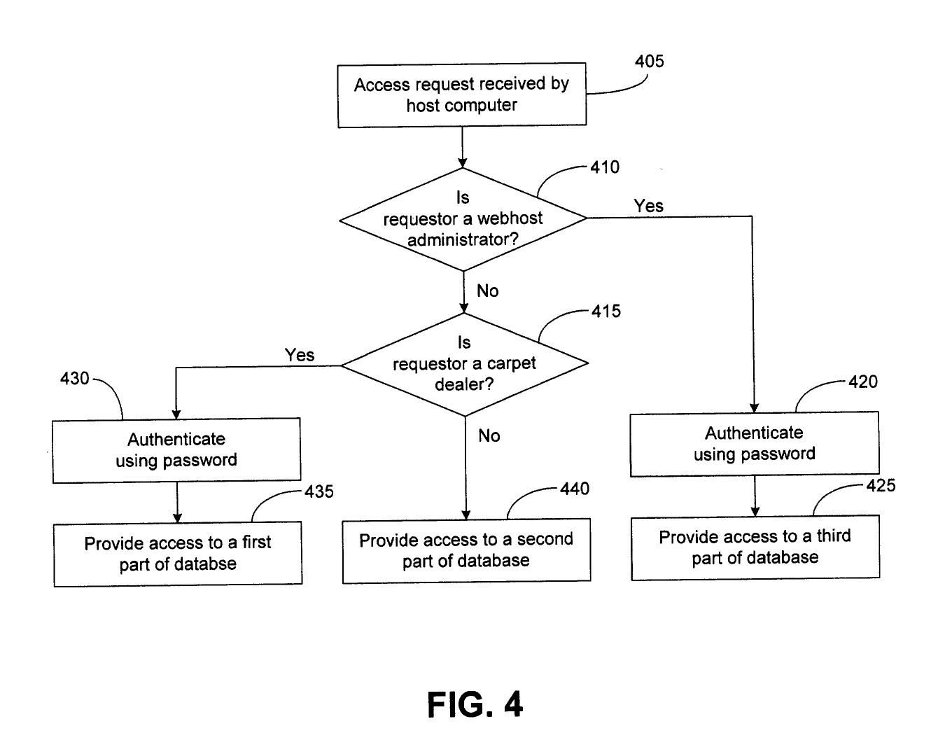

FIG. 4 is a flow chart describing operational details of the sales system of the present invention. Block 405 shows an access request that is received by webhost computer 110 (of FIG. 1). This access request may have originated from one of several different requestors such as a carpet manufacturer, a carpet dealer, or a commercial carpet customer. The flow chart of FIG. 4 is used to determine what action needs to be taken, such action depending on the type of the requestor. Block 410 is a selector block that is used to identify whether the requestor is a webhost administrator as described earlier. If the requestor is a webhost administrator, determined for example by his username, block 410 is followed by block 420. Block 420 is used to authenticate the password of the webhost administrator. If the password authentication fails access is denied, but if the password is legitimate, block 425 is implemented subsequent to block 420. Block 425 provides access to the webhost administrator to a part of the database that allows updates of the information database inside the host computer 110 as described earlier. This part of the database is referred to in FIG. 4 as a third part of the database for identification purposes.

If the selector block 410 does not authorize access for the requestor as a webhost administrator, block 415 is used to identify the requestor as a carpet dealer. If the requestor is identified as a carpet dealer, maybe by use of a username, his password is authenticated in block 430. Upon proper authentication, the carpet dealer is allowed access to a first part of the database that relates, for example, to dealer pricing and purchases.

If the requestor is not identified as a carpet dealer in block 415, the default identity as a commercial carpet customer is used and the requestor is provided access (Block 440) to a second part of the database. This part of the database may, for example, provide information on the pricing available for customers, such pricing being different from the one available to the carpet dealer.

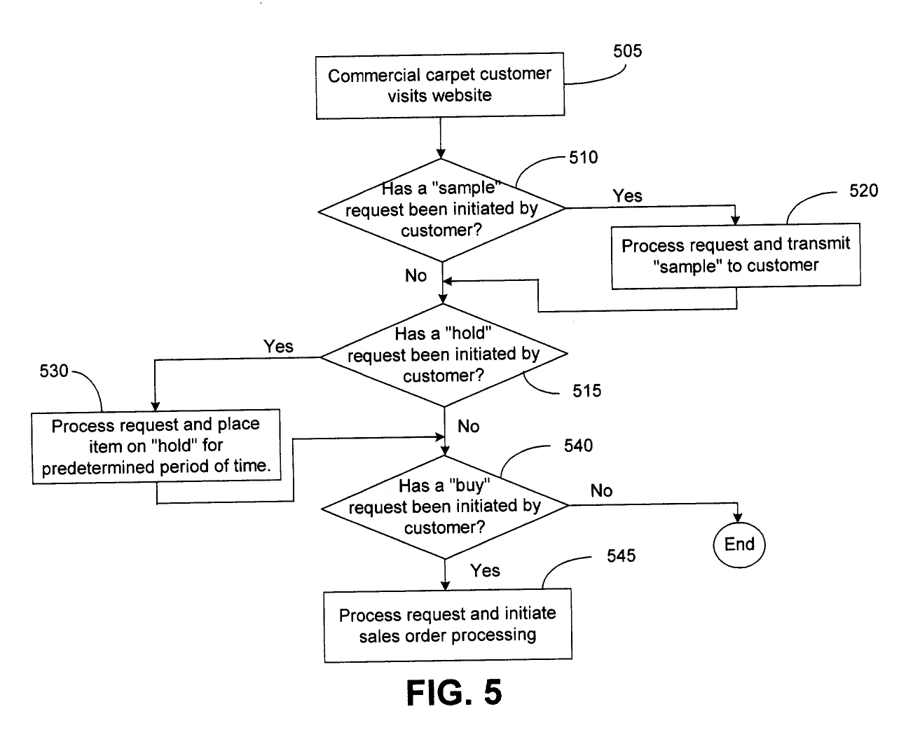

FIG. 5 is a flow chart describing a typical operation when a customer visits the sales website. A commercial carpet customer looking to purchase the select inventory of carpets enters the appropriate universal resource locator (URL) of the website via his Internet browser in block 505. After perusing the inventory, the customer may decide to obtain a closer look at the merchandise by requesting a “sample” (block 510). If such a sample request is made, by the customer entering the appropriate information (name, address etc.), the request is processed in block 520 and arrangements are made to have the sample shipped out to the customer.

Block 515 is used to determine if the customer places a “hold” request for a particular item of carpet. If such a request is made, the item is placed on hold for a predetermined period of time (days, weeks) in block 530. Block 540 is used to determine if a purchase request has been made by the customer. If such a request has been made, a sales order process is initiated in block 545. Sales order processing includes credit card processing as well as obtaining shipping information for transmitting the purchased item to the customer.

It should be emphasized that the description provided is merely to set forth a clear understanding of the principles of the invention. Many variations and modifications may be made to the above-described embodiment(s) of the invention without departing substantially from the spirit and principles of the invention. All such modifications and variations are included herein within the scope of this disclosure and the present invention and protected by the following claims.

1. A method of selling a select inventory of commercial carpets, the method comprising:
providing an information database of selected commercial-grade carpets in a computer coupled to the Internet;
providing a first authenticated access procedure to permit access by a carpet dealer to the a first part of the information database; and
providing a second authenticated access procedure to permit access by a commercial carpet customer to a second part of the information database.

2. The method of claim 1, wherein providing the information database comprises providing product information, purchase information, a first pricing information, and a second pricing information.

3. The method of claim 2, wherein providing the first authenticated access comprises providing the carpet dealer access to the first pricing information and the second pricing information.

4. The method of claim 3, wherein providing the second authenticated access comprises providing the commercial carpet customer access to the first pricing information and preventing the commercial carpet customer access to the second pricing information.

5. The method of claim 4, wherein the selected commercial-grade carpets comprises carpets that are seconds, over-runs, off-color, discontinued styles, or have minor manufacturing defects.

6. An Internet-based sales system, the sales system comprising:
a host computer configured to operate as a webhost server coupled to the Internet;
a database storage in the host computer, the database storage containing information on selected commercial-grade carpets;
means for accessing a first part of the database storage by a carpet dealer, over the Internet;
means for accessing a second part of the database storage by a commercial carpet customer, over the Internet; and
means for facilitating e-commerce transactions over the Internet.

7. The sales system of claim 6, wherein the database storage comprises a computer-readable medium of the host computer.

8. The sales system of claim 7, wherein means for accessing a first part of the database storage comprises a first personal computer configured to communicate a dealer password to the host computer and receive validation permitting access to the first part of the database.

9. The sales system of claim 8, wherein means for accessing a second part of the database storage comprises a second personal computer configured to communicate a customer password to the host computer and receive validation to access the second part of the database.

10. The sales system of claim 9, further comprising means to permit access by a webhost administrator to a third part of the database storage, and means to prevent access by a carpet dealer or a commercial carpet customer to the third part of the database.

11. The sales system of claim 10, further comprising means to prevent access by the commercial carpet customer to the first part of the database.

12. The sales system of claim 11, wherein means for facilitating e-commerce transactions over the Internet comprises means for communicating product information, pricing information, inventory information, and product shipping information to the commercial carpet customer.

13. The sales system of claim 12, wherein means for facilitating e-commerce transactions over the Internet comprises credit card transactions over the Internet.

14. The sales system of claim 13, wherein the selected commercial-grade carpets comprises carpets that are seconds, over-runs, off-color, discontinued styles, or have minor manufacturing defects.

15. A job-execution program stored on a computer-readable medium, the program comprising:
logic configured to provide a database of information on selected commercial-grade carpets;
logic configured to authenticate access by a carpet dealer to a first part of the database over the Internet;
logic configured to authenticate access by a commercial carpet customer to a second part of the database over the Internet; and
logic configured to implement a payment transaction over the Internet;

16. The program of claim 15, further comprising logic configured to prevent access by the commercial carpet customer to the first part of the database.

17. The program of claim 16, further comprising logic configured to permit a webhost administrator to update the database using a third part of the database while preventing access by the carpet dealer or the commercial carpet customer to the third part of the data base.

18. The program of claim 17, wherein the selected commercial-grade carpets comprises carpets that are seconds, over-runs, off-color, discontinued styles, or have minor manufacturing defects.
